(19) United States
(12) Patent Application Publication
(10) Pub. No.: US 2015/0323359 A1
(43) Pub. Date: Nov. 12, 2015

(54) Ultrasonic, Flow Measuring Device

(71) Applicant: ENDRESS+HAUSER FLOWTEC AG, Reinach (CH)

(72) Inventors: Pierre UEBERSCHLAG, Saint-Louis (FR); Oliver BRUMBERG, Rheinfelden (DE); Marco ANKLIN, Zwingen (CH)

(21) Appl. No.: 14/410,758

(22) PCT Filed: Jun. 4, 2013
(86) PCT No.: PCT/EP2013/061420

§ 371 Date: Dec. 23, 2014

(30) Foreign Application Priority Data
Jun. 28, 2012 (DE) 10 2012 105 719.2

(51) Int. Cl. G01F 1/66

(52) U.S. Cl. CPC G01F 1/667; G01F 1/662

(57) ABSTRACT

An ultrasonic, flow measuring device including a measuring tube and at least two ultrasonic transducers having, in each case, two electrical connections. The ultrasonic transducers are arranged in or on the measuring tube for determining the flow velocity and/or the volume flow of a medium flowing through the measuring tube based on the travel-time difference method. The flow measuring device has an electrical circuit for operating the ultrasonic transducer. A first ultrasonic transducer of the two ultrasonic transducers is switchable in such a manner that, under action of an exciter signal, it emits an ultrasonic signal into the medium, and a second ultrasonic transducer of the two ultrasonic transducers is switchable in such a manner that, upon arrival of the ultrasonic signal, it returns a received signal, characterized in that the circuit includes at least one connection to one of the connections of one of the two ultrasonic transducer, in order that the ultrasonic transducer can be short-circuited for preventing a disturbance signal.

The invention relates to an ultrasonic, flow measuring device as defined in the preamble of claim 1.

Ultrasonic, flow measuring devices are often applied in process and automation technology for measuring volume and/or mass flow of a medium through a pipeline. In such case, the travel-time difference method can be used. The travel-time difference method is known per se. The medium can be a gaseous, vaporous or liquid medium.

The essential component of an ultrasonic transducer is a piezoelectric element. The essential component of a piezoelectric element is a piezoceramic layer metallized in at least one portion. Especially, the piezoceramic layer is a film or membrane. By applying an electrical exciter signal, the piezoceramic layer is caused to oscillate and radiates via a coupling element an ultrasonic, measurement signal with a defined signal form at an angle of incidence into the pipeline. The receiving of the ultrasonic, measurement signal after passing through the pipeline or measuring tube occurs in reverse manner. Problematic is that after the transmitting and/or after the receiving of the ultrasonic, measurement signal a post-pulse oscillation of a piezoelectric element, respectively of the ultrasonic transducer as a whole, occurs. This superimposes with the ultrasonic, measurement signal, respectively the actual wanted signal, and is noticed as noise.

It is, consequently, an object of the present invention to provide an ultrasonic, flow measuring device and a method for determining the propagation velocity of ultrasonic waves in a medium, in the case of which measured values have a reduced noise coming from post-pulse oscillation of ultrasonic transducers.

The invention achieves this object by an ultrasonic, flow measuring device as defined in claim 1 and by a method as defined in claim 12.

In such case, an ultrasonic, flow measuring device includes a measuring tube and at least two ultrasonic transducers having, in each case, at least two connections. The ultrasonic transducers are arranged in or on the measuring tube, in order to enable a determining of the flow velocity of a medium flowing through the measuring tube based on the travel-time difference method. The ultrasonic transducers are arranged in an electrical circuit, wherein a first ultrasonic transducer of the at least two ultrasonic transducers is switchable in such a manner that, under action of an exciter signal, it emits an ultrasonic signal into the medium and wherein a second ultrasonic transducer of the at least two ultrasonic transducers is switchable in such a manner that, upon arrival of the ultrasonic signal, it returns a received signal. According to the invention, the aforementioned circuit includes at least one connection to at least one of the connections of an ultrasonic transducer, in order that at least one of the at least two ultrasonic transducers can be short-circuited for preventing a post-pulse oscillation of the ultrasonic transducer.

This can preferably occur in such a manner that the two connections are switchable to ground, thus, to the same potential, or that the two connections are connectable to one another or at least one of the connections is connected with an impedance less than that of the piezo crystal of the ultrasonic transducer, preferably with an impedance up to 1000 ohm, for example, a coil. In this case, the impedance produces a short circuit in the sense of the present application.

By short-circuiting an ultrasonic transducer, noise brought about by a post-pulse oscillation of the ultrasonic transducer can advantageously be lessened or suppressed.

Advantageous embodiments of the invention are subject matter of the dependent claims.

Advantageously, the circuit has at least two connections, especially ground connections, with which at least the first and the second of the at least two ultrasonic transducer are short-circuitable. In this way, the signal to noise ratio can be improved, since the transmitter and the receiver decay faster due to the added attenuation.

In order further to reduce disturbance signals resulting from post-pulse oscillation, it is advantageous to have the number of connections, especially ground connections, equal the number of ultrasonic transducers, in such a manner that each ultrasonic transducer is short-circuitable.

Advantageously, a connection can have a switch, especially a ground switch, with which the connection can be completed or interrupted. This simple circuit construction provides good control of the short-circuiting.

The circuit can be embodied in such a manner that at least each one of two parallel connected lines has, in each case, one of the two ultrasonic transducers, wherein along each of the parallel lines, in each case, at least two analog switches, are arranged, between which the particular ultrasonic transducer is arranged.

The ultrasonic, flow measuring device can especially be applied for determining the flow velocity of gases and/or gas mixtures, especially for determining the flow velocity and the composition of biogas, since in the case of such application the excitation signal and the wanted signal can differ from one another by more than 100 dB, so that noise without connection of the short-circuit would be especially negative in this application.

According to the invention, an ultrasonic, flow measuring device for determining the flow velocity and/or the volume flow of a medium flowing through the measuring tube applies a method for determining the propagation velocity of ultrasonic waves in a medium, especially with an ultrasonic, flow measuring device, by means of at least two ultrasonic transducers, which are connected in a circuit in parallel with one another, wherein the method includes steps as follows:

a) receiving an exciter signal E from an exciter element and emitting an ultrasonic signal US into a medium by the first ultrasonic transducer during a transmission phase (TP); and
b) receiving the ultrasonic signal US and transmitting a received signal R to an evaluation unit by the second of the at least two ultrasonic transducers during a receiving phase, wherein during the transmission phase the second ultrasonic transducer and/or during the receiving phase the first ultrasonic transducer short are/is circuited.

A flow measuring device, which can execute a corresponding method, suppresses noise brought about by crosstalk from an ultrasonic transducer, respectively the therein provided piezoelement. This method can be applied in the travel-time difference method for determining the flow velocity of a medium in a pipe or tube.

The invention will now be explained in greater detail based on the appended drawing, the figures of which show as follows:

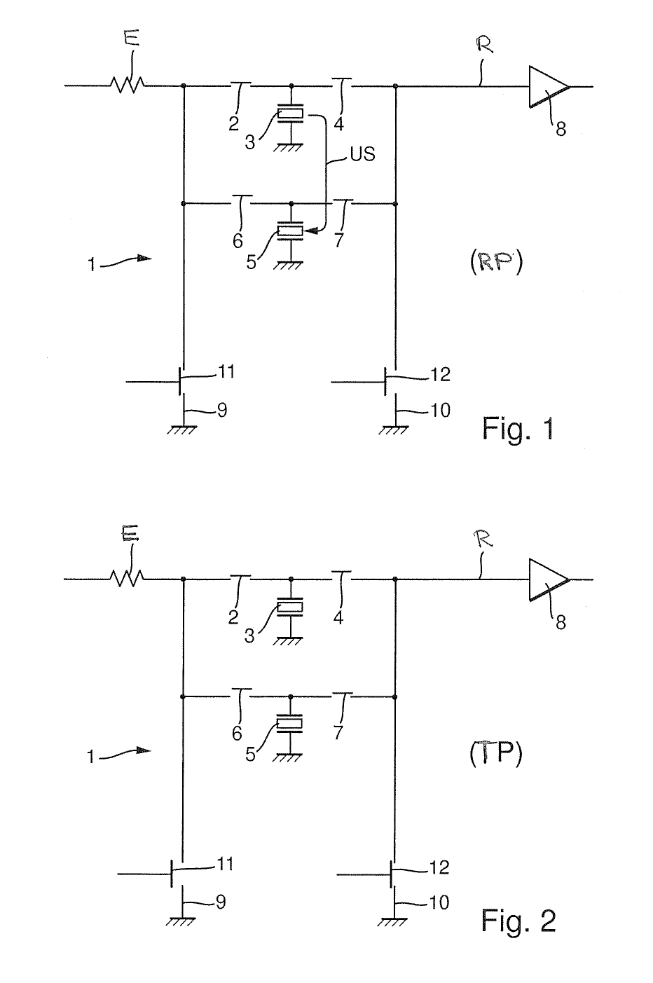

FIG. 1 a schematic circuit diagram of a circuit arranged in an ultrasonic, flow measuring device of the invention and located in a receiving phase;

FIG. 2 a schematic circuit diagram of the circuit located in a transmission phase; and

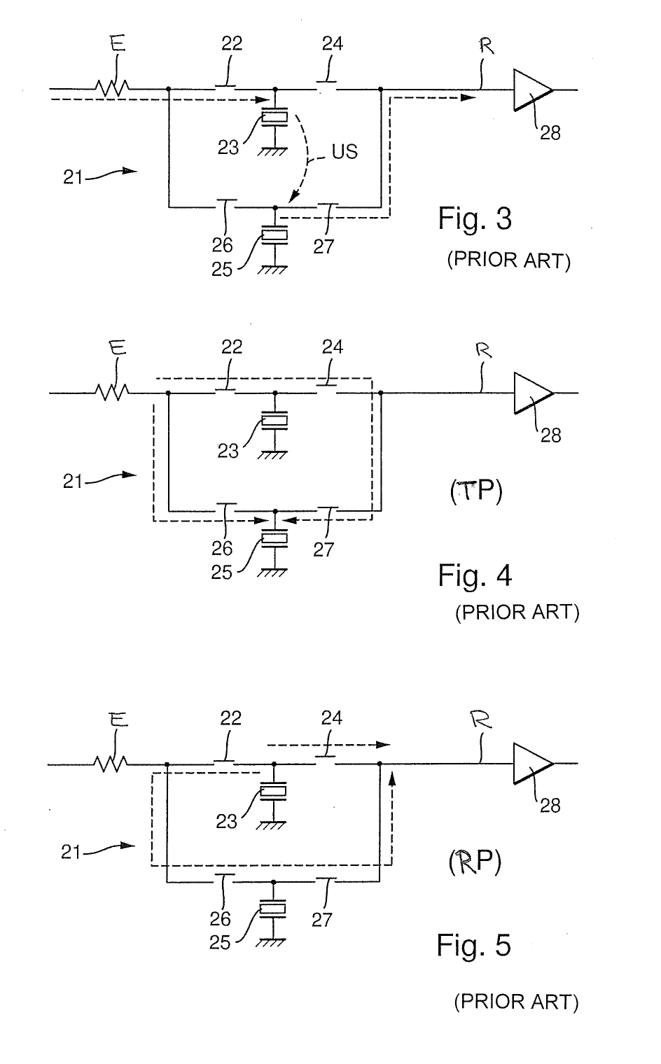

FIGS. 3-5 schematic circuit diagrams for a circuit of an ultrasonic, flow measuring device according to the state of the art.

FIGS. 3-5 show an already known circuit of ultrasonic transducers in a flow measuring device working according to the per se known, travel-time difference method.

Based on FIG. 3, the underlying task definition in the state of the art will be described in greater detail.

FIG. 3 shows a usual signal transmission of an ultrasonic signal. The simplified circuit 21 of FIG. 3 includes at least four analog switches and two ultrasonic transducers connected in parallel with one another. Two analog switches are arranged in each path, respectively one in front of and one behind each of the ultrasonic transducers. Connected after the circuit is an evaluation system, which here is illustrated by just a receiver stage 28.

Proceeding from a schematically illustrated exciter element E, especially a push-pull stage, an exciter signal, in a first operating state of circuit 21, passes through a first closed analog switch 22 and excites a first ultrasonic transducer 23 to emit an ultrasonic signal US. In such case, a second analog switch 24, which is arranged on the path behind the first ultrasonic transducer 23, is open, so that the exciter signal cannot reach the evaluation system. The first ultrasonic transducer 23 functions, thus, in the first operating state as a transmitter. The ultrasonic signal US is led into the medium to be measured and received by the second ultrasonic transducer 25. The second ultrasonic transducer 25 is switched in the first operating state as a receiver, which means that the third analog switch 26 located between the exciter element and the second ultrasonic transducer 25 is open, so that the second ultrasonic transducer receives no exciter signal. At the same time, the fourth analog switch 27 arranged between the second ultrasonic transducer 25 and the evaluation system is closed, so that the second ultrasonic transducer 25 converts the received ultrasonic signal US into a received signal R and can forward this to the evaluation system.

Then, a switching into a second operating state can occur, in which the first ultrasonic transducer 23 functions as receiver and the second ultrasonic transducer 25 as transmitter. To accomplish this, all analog switches are switched to their alternate positions.

The circuit shown in FIG. 3 has, on the whole, proved to be workable under ideal conditions.

Problematic, however, is that the piezo crystal of the first ultrasonic transducer 23, respectively that of the transmitter, still continues to oscillate after its excitation. This post-pulse oscillation is in the case of non-ideal circuits, which are often present in the real case, detected as noise, respectively a disturbance signal. In such case, the significance of the disturbance signal depends on frequency, since the analog switches act more or less well at isolating, wherein an analog switch at 50 dB has a worse isolating effect than at 100 dB. This noise is superimposed on the wanted signal. This effect is shown schematically in FIG. 5.

Moreover, also the receiver is affected by the non-ideal isolation of the switches from the exciter signal and post pulse oscillates. Also in this case, noise is generated, which superimposes on the wanted signal and makes the detection of the wanted signal difficult. This effect is illustrated in FIG. 4.

Given this background, FIGS. 1 and 2 show an electrical circuit implemented in a flow measuring device of the invention for reducing or ideally completely suppressing noise produced by post-pulse oscillation of the transmitter, respectively excitation of the receiver.

In such case, the circuit of FIGS. 3-5 is supplemented before the analog switches 2, respectively 22, and 6, respectively with a first ground connection 9 with a first ground switch 11 and after the analog switches 4 and 7 with a second ground connection 10 with a second ground switch 12. By closing the ground switches 11 and 12, respectively, the first ultrasonic transducer 3, thus the transmitter, and the second ultrasonic transducer 5, thus the receiver, can be short-circuited.

The way in which the circuit modified according to the invention works will now be explained in greater detail. For this, the first operating state, with the first ultrasonic transducer as transmitter and the second ultrasonic transducer as receiver, will be divided into two subcategories, a transmission phase TP and a receiving phase RP.

The circuit during the transmission phase is shown in FIG. 2 and the circuit during the receiving phase is shown in FIG. 1.

First, an exciter signal in the case of closed analog switch 2 excites the ultrasonic transducer 3 to oscillate, so that this emits the ultrasonic signal US into a medium to be measured. In such case, the receiver, respectively the second ultrasonic transducer 5, is short-circuited up to the transmitting of the ultrasonic signal US.

After the emitting of the ultrasonic signal, the transmitter, respectively the first ultrasonic transducer, is short-circuited, in order to suppress a post-pulse oscillation of the transmitter, and the short circuiting of the receiver is canceled, until after the receipt of the signal.

During the transmission phase TP, the first ground switch 12 is connected, respectively closed, and therewith a ground connection 10 is produced. At the same time, the second ground switch 11 remains open. In this way, the receiver is short-circuited during the transmission phase. The electrical exciting of the receiver is thereby prevented. Thus, the receiver produces no mechanical post-pulse oscillation and no disturbance signal during the receiving phase.

During the receiving phase RP, the second ground switch 11 is closed and the first ground switch 12 open. In this way, the transmitter is short-circuited. As a result, mechanical post-pulse oscillation of the transmitter cannot cause a disturbance signal.

Resistors are placed in front of the ground switches 11 and 12 for lessening disturbances.

The problem illustrated in FIGS. 3-5 results especially in the case of measuring the flow velocity of gases or gas mixtures and is less in the case of measuring liquids. This is caused, among other things, by the fact that the amplitude ratio, exciter signal/wanted signal, amounts, for instance, to 60-80 dB in the case of gases or gas mixtures. This value is comparable with the isolation of analog switches, which can typically be 80-90 db. In that case, the noise brought about by mechanical post-pulse oscillation is significant especially in the case of measuring gases.

An option for controlling the reversing of the short-circuiting connections can be based on an earlier ascertained signal travel time TOF of the ultrasonic signal from the transmitter to the receiver. For example, the ground switches 11 and 12 are switched taking this signal travel time into consideration. The signal travel time can be ascertained both in the flow direction or counter to the flow direction or an average value of the two signal travel times can be obtained.

1-13. (canceled)

14. An ultrasonic, flow measuring device, comprising:
a measuring tube; and
at least two ultrasonic transducers having, in each case, two electrical connections; and
an electrical circuit for operating said ultrasonic transducers; wherein:
said ultrasonic transducers are arranged in or on the measuring tube for determining flow velocity and/or volume flow of a medium flowing through the measuring tube based on the travel-time difference method; and
a first ultrasonic transducer of said two ultrasonic transducers is switchable in such a manner that, under action of an exciter signal, it emits an ultrasonic signal into the medium, and a second ultrasonic transducer of said two ultrasonic transducers is switchable in such a manner that, upon arrival of said ultrasonic signal, it returns a received signal; and;
said electrical circuit includes at least one connection to one of the connections of one of said two ultrasonic transducers, in order that the ultrasonic transducer can be short-circuited for preventing a disturbance signal.

15. The ultrasonic, flow measuring device as claimed in claim 14, wherein:
said at least one connection is a ground connection.

16. The ultrasonic, flow measuring device as claimed in claim 14, wherein:
said at least one connection connects two connections with one another, or said at least one connection is to an impedance less than that of the piezo crystal of the ultrasonic transducer.

17. The ultrasonic, flow measuring device as claimed in claim 14, wherein:
said electrical circuit has at least two connections, with which at least the first and the second of said ultrasonic transducers can be short-circuited.

18. The ultrasonic, flow measuring device as claimed in claim 14, wherein:
said at least one connection has a switch, with which said at least one connection can be opened or closed.

19. The ultrasonic, flow measuring device as claimed in claim 14 wherein:
said electrical circuit is embodied in such a manner that it enables a transmission phase, in which the ultrasonic signal is emitted, and a receiving phase, in which the ultrasonic signal is received; and
the first of said ultrasonic transducers, which acts as a transmitter, is short-circuited in said receiving phase.

20. The ultrasonic, flow measuring device, as claimed in claim 14, wherein:
said electrical circuit is embodied in such a manner that it enables a transmission phase, in which the ultrasonic signal is emitted, and a receiving phase, in which the ultrasonic signal is received; and
the second of said ultrasonic transducers, which acts as a receiver, is short-circuited in said transmission phase.

21. The ultrasonic, flow measuring device as claimed in claim 1r. wherein:
said electrical circuit has at least two lines connected in parallel, with each containing one of said two ultrasonic transducers; and
along each of the parallel lines, in each case, at least two analog switches are arranged, between which the respective ultrasonic transducer is arranged.

22. The ultrasonic, flow measuring device as claimed in claim 19, wherein:
in the receiving phase and in the transmission phase, in each case, at least one analog switch along a parallel line and at least one ground switch of the circuit are open.

23. The use of an ultrasonic, flow measuring device as claimed in claim 14 for determining flow velocity and/or volume flow of gases and/or gas mixtures, especially for determining the flow velocity and/or the composition of biogas.

24. The use of an ultrasonic, flow measuring device as claimed in claim 14 for determining flow velocity and/or volume flow of a medium, wherein the ultrasonic, flow measuring device is embodied as a clamp-on device.

25. An ultrasonic, flow measuring device for determining flow velocity and/or volume flow of a medium flowing through a measuring tube and embodied to perform a method for determining the propagation velocity of ultrasonic waves in a medium by means of at least two ultrasonic transducers, which are connected in a circuit in parallel with one another, wherein the method comprises the steps of:
a) receiving an exciter signal from an exciter element and emitting an ultrasonic signal into a medium by the first ultrasonic transducer during a transmission phase; and
b) receiving said ultrasonic signal and transmitting a received signal to an evaluation unit by the second of the at least two ultrasonic transducers during a receiving phase, wherein:
during said transmission phase said second ultrasonic transducer and/or during said receiving phase said first ultrasonic transducer are/is short-circuited.

26. The ultrasonic, flow measuring device as claimed in claim 14, wherein:
the short-circuiting by said at least one connection occurs as a function of an ascertained, averaged, signal travel time.
